(19) United States
(12) Patent Application Publication
(10) Pub. No.: US 2023/0235253 A1
(43) Pub. Date: Jul. 27, 2023

(54) CLEANING AGENT COMPOSITION

(71) Applicant: KOBAYASHI PHARMACEUTICAL CO., LTD., Osaka-shi, Osaka (JP)

(72) Inventors: Yoshito KOKAJI, Ibaraki-shi, Osaka (JP); Taketo HANAI, Ibaraki-shi, Osaka (JP)

(21) Appl. No.: 18/001,501

(22) PCT Filed: Aug. 3, 2021
(86) PCT No.: PCT/JP2021/028701

§ 371 Date: Dec. 12, 2022

(30) Foreign Application Priority Data
Sep. 28, 2020 (JP) 2020-162532

(51) Int. Cl. C11D 7/32; C11D 7/36

(52) U.S. Cl. CPC C11D 7/3209; C11D 7/36

(57) ABSTRACT

The objective of the present invention is to provide a cleaning agent composition which contains a tertiary amine, and can suppress discoloration that occurs over time. This cleaning agent composition can suppress discoloration that occurs over time, by mixing a chelating agent together with a tertiary amine.

### TECHNICAL FIELD

The present invention relates to a cleaning agent composition that contains a tertiary amine compound and can suppress discoloration that occurs over time.

### BACKGROUND ART

Conventionally, various cleaning agent compositions have been used to remove dirt adhering to a hard surface such as a toilet bowl and to create a hygienic environment. For example, as a cleaning agent composition for a flush toilet, a cleaning agent composition designed to be able to elute a cleaning agent into flushing water by being installed in a hand-washing part of a flush toilet, a surface of a toilet bowl, a water storage tank, or the like is used.

Conventionally, various components such as a surfactant and a sterilizer are blended in a cleaning agent composition in order to improve a washing effect and a sterilization effect. In addition, in the cleaning agent composition, a tertiary amine may be blended to improve functionality (for example, see Patent Document 1), and even when not further intentionally blended, a tertiary amine may be inevitably contained due to blending of other components. However, conventionally, the storage stability of the cleaning agent composition containing a tertiary amine has not been sufficiently studied.

### PRIOR ART DOCUMENT

### Patent Document

Patent Document 1: Japanese Patent Laid-open Publication No. 2019-526533

### SUMMARY OF THE INVENTION

The present inventors have studied the storage stability of the cleaning agent composition containing a tertiary amine, and have found that there is a unique problem that discoloration (yellowing) occurs over time. Accordingly, an object of the present invention is to provide a cleaning agent composition that contains a tertiary amine compound and can suppress discoloration that occurs over time.

### Means for Solving the Problem

As a result of conducting intensive studies to solve the above problem, the present inventors have found that discoloration that occurs over time can be suppressed by blending a chelating agent in a cleaning agent composition containing a tertiary amine. The present invention has been completed by further conducting studies based on this finding.

That is, the present invention provides inventions of the following aspects.

Item 1. A cleaning agent composition containing a tertiary amine and a chelating agent.

Item 2. The cleaning agent composition according to Item 1, in which the tertiary amine is a tertiary amine containing two hydrocarbon groups having 1 to 5 carbon atoms and one hydrocarbon group having 6 to 20 carbon atoms.

Item 3. The cleaning agent composition according to Item 1 or 2, in which the tertiary amine is at least one selected from the group consisting of dimethyloctylamine, dimethyldecylamine, dimethyldodecylamine, dimethyltetradecylamine, dimethylhexadecylamine, and dimethyloctadecylamine.

Item 4. The cleaning agent composition according to any one of Items 1 to 3, in which the chelating agent is an aminocarboxylic acid-based chelating agent and/or a phosphonic acid-based chelating agent.

Item 5. The cleaning agent composition according to any one of Items 1 to 4. in which the chelating agent is al least one selected from the group consisting of ethylenediaminetetraacetic acid, nitrilotriacetic acid, and hydroxyethylidene diphosphonic acid.

Item 6. The cleaning agent composition according to any one of Items 1 to 5, in which the tertiary amine is contained in an amount of 0.005 to 0.5 wt %.

Item 7. A method for suppressing discoloration of a cleaning agent composition containing a tertiary amine, including allowing a cleaning agent composition to contain a tertiary amine and a chelating agent.

### Advantages of the Invention

The cleaning agent composition of the present invention contains a combination of a tertiary amine and a chelating agent, such that discoloration that occurs over time can be suppressed. Therefore, the cleaning agent composition can have excellent stability and can maintain an excellent appearance.

### EMBODIMENTS OF THE INVENTION

### 1. Cleaning Agent Composition

A cleaning agent composition of the present invention contains a tertiary amine and a chelating agent. Hereinafter, the cleaning agent composition of the present invention will be described in detail.

### [Tertiary Amine]

The cleaning agent composition of the present invention contains a tertiary amine. Preferred examples of the tertiary amine contained in the cleaning agent composition of the present invention include a compound in which three hydrogen atoms of ammonia are substituted with hydrocarbon groups.

The tertiary amine contained in the cleaning it composition of the present invention may be intentionally blended or unintentionally blended. For example, a tertiary amine such as alkyl (C8-18) dimethyl amine as an impurity is inevitably contained in a alkyl(C8-18)dimethybenzylammonium salt, but the present invention is also applied to a cleaning agent composition in which a tertiary amine is inevitably contained as an impurity by blending a alkyl(C8-18)dimethybenzlammonium salt.

Specific examples of the tertiary amine contained in the cleaning agent composition of the present invention include a tertiary amine containing two hydrocarbon groups having 1 to 5 carbon atoms and one hydrocarbon group having 6 to 20 carbon atoms, preferably a tertiary amine containing two hydrocarbon groups having 1 to 3 carbon atoms and one hydrocarbon group having 8 to 18 carbon atoms, more preferably a tertiary amine containing two methyl groups and one hydrocarbon group having 10 to 16 carbon atoms, and still more preferably a tertiary amine containing two methyl groups and one hydrocarbon group having 12 to 14 carbon atoms. When such a tertiary amine is contained in the cleaning agent composition, discoloration over time tends to occur remarkably in the prior art. However, according to the present invention, discoloration over time can be effectively suppressed even when such a tertiary amine is contained.

More specific examples of the tertiary amine contained in the detergent composition of the present invention include dimethyloctylamine, dimethyldecyl amine, dimethyldodecylamine, dimethyltetradecylamine, dimethylhexadecylamine, and dimethyloctadecylamine; preferably dimethyldecylamine, dimethyldodecylamine, dimethyltetradecylamine, and dimethythexadecylamine; and more preferably dimethyldodecylamine and dimethyltetradecylamine.

In the cleaning agent composition of the present invention, these tertiary amines may be contained alone or may be contained in combination of two or more thereof.

A content of the tertiary amine in the cleaning agent composition of the present invention is, for example, 0.001 to 1 wt %. From the viewpoint of more efficiently suppressing discoloration over time, the content of the tertiary amine in the cleaning agent composition of the present invention is preferably 0.005 to 0.5 wt %, more preferably 0.025 to 0.25 wt %, and still more preferably 0.05 to 0.1 wt %.

### [Chelating Agent]

The cleaning agent composition of the present invention can suppress discoloration over time caused by the tertiary amine by containing a chelating agent.

The chelating agent used in the present invention may be any of an aminocarboxylic acid-based chelating agent, a phosphonic acid-based chelating agent, a polyvalent carboxylic acid-based chelating agent, and the like.

Specific examples of the aminocarboxylic acid-based chelating agent include ethylenediaminetetraacetic acid (EDTA), nitrilotriacetic acid (NTA), dihydroxyethylglycine (DEG), N-(2-hydroxyethyl)iminodiacetic acid (HEIDA), hydroxyethylethylenediaminetetraacetic acid (HEDTA), diethylenetriaminepentaacetic acid (DTPA), hydroxyethylethylenediaminetriacetic acid (HEDTA), methylglycine diacetic acid (MGDA), glutamic acid diacetic acid (GLDA), aspartic acid diacetic acid (ASDA), ethylene diamine succinic acid (EDDS), hydroxyiminodisuccinic acid (HIDS), iminodisuccinic acid (IDS), and salts thereof (alkali metal salts such as sodium salts).

Specific examples of the phosphonic acid-based chelating agent include hydroxyethylidene diphosphonic acid (HEDP), nitriloiris(methylene phosphonic acid) (NTMP), phosphonobutanetricarboxylic acid (PBTC), ethylenediamine tetra(methylene phosphonic acid) (EDTMP), and salts thereof (alkali metal salts such as sodium salts).

Specific examples of the polyvalent carboxylic acid-based chelating agent include acetic acid, adipic acid, monochloroacetic acid, oxalic acid, succinic acid, oxydisuccinic acid, carboxymethylsuccinic acid, carboxymethyloxysuccinic acid, glycolic acid, diglycolic acid, lactic acid, tartaric acid, carboxymethyltartaric acid, citric acid, malic acid, gluconic acid, and salts thereof (alkali metal salts such as sodium salts).

Among these chelating agents, an aminocarboxylic acid-based chelating agent and a phosphoric acid-based chelating agent are preferable, and EDTA, NTA, HEDP, and salts thereof are more preferable, from the viewpoint of more effectively suppressing discoloration over time.

In the cleaning agent composition of the present invention, these chelating agents may be used alone or may be used in combination of two or more thereof.

A content of the chelating agent in the cleaning agent composition of the present invention is, for example, 0.00001 to 5 wt %. From the viewpoint of more efficiently suppressing discoloration over time, the content of the chelating agent in the cleaning agent composition of the present invention is preferably 0.0005 to 1 wt %, and more preferably 0.001 to 0.1 wt %.

In the cleaning agent composition of the present invention, a ratio of the tertiary amine to the chelating agent is determined depending on the content of each component described above, and from the viewpoint of more effectively suppressing discoloration that occurs over time, for example, the amount of the chelating agent is 0.01 to 10,000 parts by weight, preferably 0.1 to 1,000 parts by weight, more preferably 1 to 100 parts by weight, per 100 parts by weight of the tertiary amine.

### [Surfactant]

The cleaning agent composition of the present invention preferably contains a surfactant. The type of the surfactant used in the present invention is not particularly limited, and may be any of a nonionic surfactant, a cationic surfactant, an anionic surfactant, and an amphoteric surfactant.

Examples of the nonionic surfactant include polyoxyalkylene alkyl ether (polyoxyethylene alkyl ether, polyoxypropylene alkyl ether, or polyoxyethylene polyoxypropylene alkyl ether), polyoxyethylene glycerin fatty acid ester, polyoxyethylene sorbitan fatty acid ester, polyoxyethylene sorbitol fatty acid ester, polyglycerin fatty acid ester, glycerin fatty acid ester, sorbitan fatly acid ester, polyethylene glycol fatty acid ester, propylene glycol mono-fatty acid ester, alkyl polyhydric alcohol ether, a polyoxyalkylene block polymer, polyoxyethylene alkylphenyl ether, polyoxyethylene alkylamine, fatty acid alkanolamide, acyl methyl glucamide, polyoxyethylene acetylene glycol, polyoxyethylene lanolin, polyoxyethylene lanolin alcohol, polyoxyethylene castor oil, polyoxyethylene hydrogenated castor oil, polyoxyethylene phytosterol, polyoxyethylene cholestanol, polyoxyethylene nonylphenyl formaldehyde condensate, and alkyl glucoside.

Examples of the cationic surfactant include an amidoamine salt-based surfactant such as stearic acid diethylaminoethylamide glutamate or lanolin fatty acid diethylaminoethylamide glutamate; and an amidoguanidine salt-based surfactant such as lauramide guanidine hydrochloride.

Examples of the anionic surfactant include alkylbenzenesulfonate, alkenylsulfonate (α-olefinsulfonate), alkyl sulfoacetate, alkylsulfate, alkanesulfonate, a higher fatty acid salt, alkyl ether carboxylate, N-acylaminate, higher fatty acid amide sulfonate, and polyoxyethylene fatty acid phosphoric acid ester salt.

Examples of the amphoteric surfactant include a betaine-based amphoteric surfactant such as betaine alkyldimethylaminoacetate; an amino acid-based amphoteric surfactant; and an amine oxide-type amphoteric surfactant.

These surfactants may be used alone or may be used in combination of two or more thereof.

Among the surfactants, a nonionic surfactant is preferable, and polyoxyalkylene alkyl ether is more preferable.

A content of the surfactant in the cleaning agent composition of the present invention may be appropriately set according to a type of surfactant to be used, a dilution ratio at the time of use, and the like, and is, for example, 10 to 60 wt %, preferably 20 to 55 wt %, and more preferably 30 to 50 wt %.

### [Other Components]

The cleaning agent composition of the present invention may further contain additives such as a colorant (a color pigment or a dye), an enzyme, a disinfectant, a chelating agent, a deodorant, an emulsifying and solubilizing agent for oily components, an extender, a solubility modifier, a bleaching agent, a water repellent, a hydrophilic agent, a filler, a pH adjuster, a thickener, a gelling agent, a moldability improver, a buffer, a clouding agent, an antifoaming agent, a lubricant, and a coating agent, if necessary, as long as the effects of the present invention are not impaired.

### [Form]

A form of the cleaning agent composition of the present invention is not particularly limited, and may be appropriately set according to an application thereof, and examples thereof include a liquid form, a solid form (a powder form, a tablet form, or the like), a semi-solid form (a paste form, a gel form, or the like), and an aerosol form. Among these forms, a liquid form and a semi-solid form are preferable, and a liquid form is more preferable.

### [Target to be Cleaned]

A target to be cleaned of the cleaning agent composition of the present invention is not particularly limited as long as sterilization or dirt removal is required, and examples thereof include a hard surface that can come into contact with water, such as a toilet (a toilet bowl or a floor of a toilet), a bathroom, a kitchen, a cooking place, a drainage pipe, and a water storage facility (a pool, an artificial pond, or the like). Among them, a toilet bowl of a flush toilet is likely to be contaminated with microorganism-derived dirt such as blackish, and is a target to be cleaned for which sterilization is required. Therefore, the cleaning agent composition of the present invention is suitable as a cleaning agent used for the toilet bowl of the flush toilet.

In a case where the cleaning agent composition of the present invention is used for cleaning a toilet bowl of a flush toilet, the cleaning agent composition of the present invention may be applied to the toilet bowl as it is and used for cleaning, but it is preferable that the cleaning agent composition is diluted with flushing water and used for cleaning the toilet bowl using flushing water when flushing the flush toilet. In the case where the cleaning agent composition of the present invention is diluted with flushing water and used for cleaning the toilet bowl of the flush toilet, a dilution ratio is not particularly limited, and is, for example, about 10,000 to 1,000,000 times, preferably about 20,000 to 500,000 times, more preferably about 30,000 to 250,000 times.

In the case where the cleaning agent composition of the present invention is diluted with flushing water and used for cleaning the toilet bowl of the flush toilet, the cleaning agent composition of the present invention may be any of a cleaning agent for an on-tank of a flush toilet, a cleaning agent for an in-tank of a flush toilet, a cleaning agent for a rim part of a flush toilet, a cleaning agent used by adhering to a surface of a toilet bowl, and the like. The cleaning agent for the on-tank of the flush toilet is used by being installed on a hand-washing part of the flush toilet, and is a cleaning agent for cleaning of the toilet bowl by releasing the flushing water in which the cleaning agent composition is dissolved into the toilet bowl through outflow of the cleaning agent composition from a container when the flushing water for cleaning supplied to the hand-washing part comes into contact with the container for housing the cleaning agent composition. The cleaning agent for the in-tank of the flush toilet is used by being put into a water storage tank of the flush toilet, and is a cleaning agent for cleaning of the toilet bowl by releasing the flushing water in which the cleaning agent composition is dissolved into the toilet bowl during flushing through outflow of the cleaning agent when the cleaning agent comes into contact with the flushing water for cleaning in the water storage tank. The cleaning agent for the rim part of the flush toilet is used by adhering to the rim part of the flush toilet, and is a cleaning agent for cleaning of the toilet bowl by releasing the flushing water in which the cleaning agent composition is dissolved into the toilet bowl through outflow of the cleaning agent composition from the container when the flushing water discharged to the toilet bowl comes into contact with a container in which the cleaning agent composition is housed. The cleaning agent used by adhering to the surface of the toilet bowl is a cleaning agent for cleaning of the toilet bowl by releasing the cleaning agent composition to the flushing water when the flushing water discharged into the toilet bowl comes into contact with the toilet bowl during fleshing, the cleaning agent being installed in a state of adhering to the surface of the toilet bowl. In the case where the cleaning agent composition of the present invention is used as a cleaning agent used by adhering to a surface of a toilet bowl, it is preferable that the cleaning agent composition of the present invention is a gel form so as to have adhesion to the surface of the toilet bowl.

### [Container for Housing]

In addition, since the cleaning agent composition of the present invention can suppress discoloration (yellowing) over time, there is an advantage that it can be stably maintained without impairing the appearance even when it is housed in a container having a transparent housing section (a housing section for housing the cleaning agent composition) that allows the inside to be seen. Therefore, preferred examples of the container for housing the cleaning agent composition of the present invention include a container having a transparent housing section. Here, the term “transparent” includes both colorless transparent and colored transparent.

In addition, a container with a blue-transparent housing section is considered unsuitable for housing a cleaning agent composition that are prone to yellowing over time, as the change in color tone is easily discernible when the detergent composition housed in the housing section turns yellow. However, in the cleaning agent composition of the present invention, discoloration (yellowing) over time can be suppressed, such that the appearance can be stably maintained even when the cleaning agent composition is housed in a container with a blue-transparent housing section. Therefore, preferred examples of the container for housing the cleaning agent composition of the present invention include a container having a blue-transparent housing section.

### 2. Discoloration Suppression Method

The present invention further provides a method for suppressing discoloration of a cleaning agent composition containing a tertiary amine. Specifically, the method is performed by allowing a cleaning agent composition to contain a tertiary amine and a chelating agent.

A type and content of the tertiary amine used in the method, a type and content of the chelating agent, types and contents of other components that can be blended in the cleaning agent composition, a target to be cleaned in a form of the cleaning agent composition, and the like are as described in the section of “1. Cleaning Agent Composition”.

### EXAMPLES

Hereinafter, the present invention will be described in detail with reference to Examples, but the present invention is not limited these Examples.

### Test Example 1

Liquid cleaning agent compositions having the compositions shown in Table 1 were prepared. All of the cleaning agent compositions immediately after the preparation were colorless and transparent. 60 ml of each of the cleaning agent compositions immediately after the preparation was housed in a 75 ml glass container and stored at 60° C. under light-shielding conditions for 2 weeks. The appearance of the cleaning agent composition was observed after storage for 2 weeks, and the discoloration suppression effect was evaluated according to the following criteria.

### <Criteria for Determination of Discoloration Suppression Effect>

⊙: No yellowing is observed at all.

○: Almost no yellowing is observed.

Δ: Slight yellowing is observed.

×: Obvious yellowing is observed.

The results are shown in Table 1. As a result, in the cleaning agent composition containing a tertiary amine (dimethyldodecylamine or dimethyltetradecylamine) but not containing a chelating agent, obvious yellowing was observed when stored at 60° C. for 2 weeks (Comparative Examples 1 to 4). On the other hand, in the cleaning agent composition containing a chelating agent (HEDP, EDTA, or NTA) together with a tertiary amine (dimethyldodecylamine or dimethyltetradecylamine), yellowing after storage at 60° C. for 2 weeks was sufficiently suppressed, and the cleaning agent composition did not have yellowing and had excellent storage stability. That is, it vas clear from the present results that discoloration could be suppressed by using a tertiary amine and a chelating agent in combination in the cleaning agent composition.

TABLE 1

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Dimethyl- | 0.1 | 0.1 | 1 | 1 | 0.1 | 0.1 | 0.1 | 0.1 | — | — | — | — |
| dodecylamine | | | | | | | | | | | | |
| Dimethyltetra- | — | — | — | — | — | — | — | — | 0.1 | 0.1 | 0.1 | 0.1 |
| decylamine | | | | | | | | | | | | |
| HEDP | 0.01 | 0.01 | 0.01 | 0.01 | — | — | — | — | 0.01 | 0.01 | — | — |
| EDTA—Na | — | — | — | — | 0.01 | 0.01 | — | — | — | — | 0.01 | 0.01 |
| NTA | — | — | — | — | — | — | 0.01 | 0.01 | — | — | — | — |
| Polyoxy- | — | 40 | — | 40 | — | 40 | — | 40 | — | 40 | — | 40 |
| alkylene | | | | | | | | | | | | |
| alkyl ether | | | | | | | | | | | | |
| Purified | Bal- | Bal- | Bal- | Bal- | Bal- | Bal- | Bal- | Bal- | Bal- | Bal- | Bal- | Bal- |
| water | ance | ance | ance | ance | ance | ance | ance | ance | ance | ance | ance | ance |
| Total (wt %) | 100 | 100 | 100 | 100 | 100 | 100 | 100 | 100 | 100 | 100 | 100 | 100 |
| Discoloration | ⊙ | ⊙ | Δ | Δ | ◯ | ◯ | ◯ | ◯ | ⊙ | ⊙ | ◯ | ◯ |
| suppression | | | | | | | | | | | | |
| effect | | | | | | | | | | | | |

| | Comparative example | | | |
|---|---|---|---|---|
| | 1 | 2 | 3 | 4 |
| Dimethyl- | 0.1 | 0.1 | — | — |
| dodecylamine | | | | |
| Dimethyltetra- | — | — | 0 1 | 0.1 |
| decylamine | | | | |
| HEDP | — | — | — | — |
| EDTA—Na | — | — | — | — |
| NTA | — | — | — | — |
| Polyoxy- | — | 40 | — | 40 |
| alkylene | | | | |
| alkyl ether | | | | |
| Purified | Bal- | Bal- | Bal- | Bal- |
| water | ance | ance | ance | ance |
| Total (wt %) | 100 | 100 | 100 | 100 |
| Discoloration | X | X | X | X |
| suppression | | | | |
| effect | | | | |

1. A cleaning agent composition comprising a tertiary amine and a chelating agent.

2. The cleaning agent composition according to claim 1, wherein the tertiary amine is a tertiary amine containing two hydrocarbon groups having 1 to 5 carbon atoms and one hydrocarbon group having 6 to 20 carbon atoms.

3. The cleaning agent composition according to claim 1, wherein the tertiary amine is at least one selected from the group consisting of dimethyloctylamine, dimethyldecylamine, dimethyldodecylamine, dimethyltetradecylamine, dimethylhexadecylamine, and dimethyloctadecylamine.

4. The cleaning agent composition according to claim 1, wherein the chelating agent is an aminocarboxylic acid-based chelating agent and/or a phosphonic acid-based chelating agent.

5. The cleaning agent composition according to claim 1, wherein the chelating agent is at least one selected from the group consisting of ethylenediaminetetraacetic acid, nitrilotriacetic acid, hydroxyethylidene diphosphonic acid and salts thereof.

6. The cleaning agent composition according to claim 1, wherein the tertiary amine is contained in an amount of 0.005 to 0.5 wt %.

7. A method for suppressing discoloration of a cleaning agent composition containing a tertiary amine, comprising allowing a cleaning agent composition to contain a tertiary amine and a chelating agent.
